(19) United States
(12) Patent Application Publication
(10) Pub. No.: US 2026/0014564 A1
(43) Pub. Date: Jan. 15, 2026

(54) MAGNETIC DIGITAL MICROFLUIDIC SYSTEM AND MICROFLUIDIC METHOD

(71) Applicant: SHENZHEN INSTITUTES OF ADVANCED TECHNOLOGY, Shenzhen (CN)

(72) Inventors: Hui YANG, Shenzhen (CN); Lin ZENG, Shenzhen (CN); Hongwei GUAN, Shenzhen (CN); Shengyu WANG, Shenzhen (CN); Yi ZHANG, Shenzhen (CN)

(21) Appl. No.: 19/337,802

(22) Filed: Sep. 23, 2025

Related U.S. Application Data
(63) Continuation-in-part of application No. PCT/CN2023/089275, filed on Apr. 19, 2023.

(51) Int. Cl. B01L 3/00; B01L 7/00

(52) U.S. Cl. CPC B01L 3/502761; B01L 7/52; B01L 2200/0668; B01L 2300/0819; B01L 2300/18; B01L 2400/043

(57) ABSTRACT

A magnetic digital microfluidic system and a microfluidic method are provided. The system includes a droplet manipulation unit, a magnetic core coil array switching unit, a logic control unit, and a signal detection unit. The droplet manipulation unit includes a microfluidic platform and a magnetic core coil array. The magnetic core coil array is arranged below the microfluidic platform and is connected to the magnetic core coil array switching unit. The logic control unit is connected to the magnetic core coil array switching unit and the signal detection unit. The present disclosure utilizes a magnetic core coil array to directly drive magnetic droplets and non-magnetic droplets in a microfluidic platform, and realizes a series of operations such as droplet control, transportation, merging, distribution, heating, and detection. This can solve the problems in which existing magnetic digital microfluidic systems are limited to driving only magnetic droplets and have poor biocompatibility.

### CROSS-REFERENCE TO RELATED APPLICATIONS

This application is a Continuation in part of International Application No. PCT/CN2023/089275, filed on Apr. 19, 2023, which is hereby incorporated by reference in its entirety.

### TECHNICAL FIELD

The present disclosure relates to a microfluidic system, specifically to a magnetic digital microfluidic system and a microfluidic method, belonging to the technical field of magnetic digital microfluidics.

### BACKGROUND

Digital microfluidic (DMF) chip technology has attracted extensive attention from researchers due to its advantages such as strong configurability, capability of processing multiple droplets simultaneously and low reagent consumption rate. This technology has been widely applied in fields such as analytical chemistry, clinical diagnosis, DNA sequencing, and environmental monitoring[1].

Meanwhile, traditional continuous-flow microfluidic systems have demonstrated high throughput and powerful fluid handling capabilities [2-4]. However, operations required to defining fluid paths and geometric constraints in microfluidic systems severely limit their adaptability and automation, and microfluidic systems in large-scale configurations impose these same limitations.

In order to address these limitations, a digital microfluidic driving technology has emerged. Compared with traditional microfluidic chips that require preparation of microchannels, digital microfluidic chips have a simple structure, do not require preparation of microchannels or microfluidic power sources, are less prone to sample clogging, contamination, and dead zones, and facilitate large-scale integration. The basis of digital microfluidic chips is digital droplet driving technology. The digital droplet driving technology based on electrowetting on dielectric (EWOD) has become a mainstream technology for driving droplets on chips due to its advantages such as good integration, convenient manipulation, and low likelihood of electrode contamination. It can transport discrete droplets on an open surface in a programmable manner [5-7]. However, this technology is also limited by the surface charge of the droplets, the manufacturing cost of electrodes (usually disposable), and the need to pre-design distribution pathways of the electrodes. The droplets can only move along the inherent path of the electrodes. These drawbacks may limit its service life and compatibility with other peripheral components, thereby affecting diversity of its applications [8-9].

Magnetic digital microfluidics refers to a digital microfluidic technology that uses magnetic force to drive and control droplets. Compared with other digital microfluidic platforms, magnetic droplets used in magnetic digital microfluidics have a plurality of functions. In addition to serving as driving actuators, they also provide a functional solid matrix for molecular targeted binding, thus being widely used in molecular diagnostics and immunodiagnostics.

A basic working principle of magnetic digital microfluidics is the interaction between magnetic fields and magnetically responsive structures. The magnetic fields can be divided into two categories: permanent magnetic fields and electromagnetic fields. The permanent magnetic fields are widely used in power-free environment, suitable for long-term outdoor biochemical analysis, and have high magnetic field strength and stronger magnetic force. However, the permanent magnets usually need to be moved by means of mechanical systems, which makes the system complex and bulky. The electromagnetic fields are much more flexible than the permanent magnetic fields because electromagnets occupy less space and have more flexible forms, such as printed circuit copper coils and electromagnetic coils, and the required magnetic field can be flexibly adjusted through electric current. Their disadvantage is that the magnetic field strength is relatively weak, resulting in insufficient driving capability for weakly magnetic droplets. At present, systems that use the electromagnetic fields to control magnetic droplets usually need an external static magnetic field to enhance the magnetic force.

The magnetically responsive structures can be divided into magnetic droplets and magnetic substrates. The former can directly drive the droplets through magnetic fields, while the latter drives the droplets through deformations of the magnetic substrates. The magnetic droplets can be droplets containing magnetic particles, ferrofluids, and magnetic liquid marbles. The droplets containing magnetic particles mainly refer to droplets with a certain amount of ferromagnetic or superparamagnetic magnetic beads. The magnetic beads drag the droplets to move through their response to the magnetic fields, and the magnetic beads also have a function of targeted binding. The ferrofluids are stable colloidal solutions composed of magnetic solid nanoparticles (usually nanoscale iron oxide or ferroferric oxide particles), a basic carrier liquid (water or oil), and surfactants, and have functions such as sample transportation, driving, and surface wetting. The ferrofluids usually have a higher magnetic susceptibility and can have a stronger magnetic response, but they also have greater frictional force when moving on solid surfaces, and it is difficult for them to have a specific binding function due to biocompatibility issues. The magnetic liquid marbles are droplets with volumes ranging from hundreds of picoliters to tens of microliters, coated with hydrophobic magnetic powders (such as iron oxide and polyethylene glycol). The droplets can be driven to move through the magnetic powders on the surface. A main difference from traditional droplets is that the magnetic powders do not form plugs inside the droplets but remain on the surface of the liquid marbles. The magnetic liquid marbles have high stability and can reduce liquid evaporation, but they are difficult to operate in droplet solution processing. The above-mentioned droplets are usually placed on hydrophobic coated planes or in oil-filled microchambers to avoid contamination. The hydrophobic coated planes or oil-filled microchambers are usually disposable, so they have high-cost requirements. The magnetic substrates are flexible hydrophobic substrates capable of magnetic deformation. The flexible substrates can be easily deformed to form indentations on the surface. The droplets roll toward the indentations with a lowest potential energy. Movements of the magnetic droplets and the non-magnetic droplets can be easily controlled by deforming and moving the positions of the indentations on the flexible substrate, but the preparation of the magnetic substrates is usually complex and expensive.

Based on the above analysis, it can be concluded that in terms of magnetic fields, although the permanent magnets can generate strong magnetic fields and have strong driving capability for magnetic droplets, they require an additional mechanical movement system to control the permanent magnets. Electromagnets, although flexible and controllable, have weak magnetic fields and usually require superposition of an external static magnetic field to drive magnetic droplets. In terms of droplets, most existing magnetic digital microfluidic systems can only manipulate magnetic droplets. Although magnetic beads have an advantage of specific binding, many ferrofluids do not have good biocompatibility, which limits downstream applications of the magnetic digital microfluidics. Moreover, the cost of magnetic substrates capable of manipulating non-magnetic droplets is much higher than that of hydrophobic coated planes or oil-based microchambers, which is not conducive to applications such as point-of-care diagnostics in different environments.

The above references are as follows:
[1] SAMIEI E, TABRIZIAN M, HOORFAR M.
   A review of digital microfluidics as portable platforms for lab-on-a-chip application [J]. Lab on a Chip, 2016, 16(13): 2376-2396.
[2] M. Antfolk, T. Laurell,
   Continuous flow microfluidic separation and processing of rare cells and bioparticles found in blood-A review. Anal. Chim. Acta 965, 9-35(2017).
[3] M. Karle, S. K. Vashist, R. Zengerle, F. von Stetten,
   Microfluidic solutions enabling continuous processing and monitoring of biological samples: A review. Anal. Chim. Acta 929, 1-22(2016).
[4] D. Di Carlo, D. Irimia, R. G. Tompkins, M. Toner,
   Continuous inertial focusing, ordering, and separation of particles in microchannels. Proc. Natl. Acad. Sci. U.S.A. 104, 18892-18897(2007).
[5] M. Abdelgawad, A. R. Wheeler, The digital revolution:
   A new paradigm for microfluidics. Adv. Mater. 21, 920-925(2009).
[6] M. G. Pollack, R. B. Fair, A. D. Shenderov, Electrowetting-based actuation of droplets for microfluidic applications. Appl. Phys. Lett. 77, 1725(2000).
[7] K. Choi, A. H. C. Ng, R. Fobel, A. R. Wheeler, Digital Microfluidics. Annu. Rev. Anal. Chem. 5, 413-440(2012).
[8] M. Mibus, G. Zangari, Performance and reliability of electrowetting-on-dielectric (EWOD) systems based on tantalum oxide. ACS Appl. Mater. Interfaces 9, 42278-42286(2017).
[9] Y. Zhang, N.-T. Nguyen, Magnetic digital microfluidics-A review. Lab Chip 17, 994-1008(2017).

### SUMMARY

One object of the present disclosure is to solve problems in which the existing magnetic digital microfluidic systems are limited to driving only magnetic droplets and have poor biocompatibility. The present disclosure provides a magnetic digital microfluidic system, which uses a magnetic core coil array to directly drive both magnetic droplets and non-magnetic droplets in a microfluidic platform, and realizes a series of droplet manipulations such as droplet control, transportation, merging, distribution, heating and detection.

Another object of the present disclosure is to provide a magnetic digital microfluidic method.

The objects of the present disclosure can be achieved by the following technical solutions:

A magnetic digital microfluidic system includes a droplet manipulation unit, a magnetic core coil array switching unit, a logic control unit and a signal detection unit, wherein the droplet manipulation unit includes a microfluidic platform and a magnetic core coil array, the magnetic core coil array is arranged below the microfluidic platform and connected to the magnetic core coil array switching unit, and the logic control unit is connected to the magnetic core coil array switching unit and the signal detection unit.

Optionally, the droplet manipulation unit further includes a magnetic core coil array heat dissipation structure, and the magnetic core coil array heat dissipation structure is stacked and nested on an outer contour of the magnetic core coil array.

Optionally, wherein the microfluidic platform is a three-layer sandwich structure, including an upper substrate, a microchannel layer and a lower substrate arranged in sequence from top to bottom.

The upper substrate includes a medium inlet, a medium outlet and a sample inlet, the medium inlet and the medium outlet are located at a periphery of the magnetic core coil array, and the sample inlet is located above the magnetic core coil array.

The microchannel layer includes a microchamber and microchannel structure, which are located directly above the magnetic core coil array, an area covered by the microchamber and microchannel structure is larger than a cross-section of the magnetic core coil array, the microchamber and microchannel structure is separated from the magnetic core coil array by the lower substrate, and connected to the medium inlet, the medium outlet, and the sample inlet.

Optionally, wherein the microchamber and microchannel structure includes a droplet basic functional area, a droplet heating functional area and a droplet detection functional area, a control area of the magnetic core coil array covers the droplet basic functional area, the droplet heating functional area and the droplet detection functional area, the droplet basic functional area is connected to the sample inlet, basic functions of the droplet basic functional area include a droplet transportation, a merging and a distribution, and the signal detection unit is arranged above the droplet detection functional area.

Optionally, wherein the microfluidic platform is a single-layer hydrophobic platform structure.

Optionally, the magnetic core coil array includes a plurality of magnetic core coils, and the magnetic core coil array can be arranged into any array shape through the plurality of magnetic core coils, and each magnetic core coil includes a magnetic core and an electromagnetic coil, and the electromagnetic coil is tightly wound around the magnetic core.

Optionally, further includes a human-computer interaction unit, which is connected to the logic control unit.

Another object of the present disclosure can be achieved by the following technical solutions:

A microfluidic method, implemented based on the above-mentioned magnetic digital microfluidic system, includes:

Filling the microfluidic platform with droplets, and controlling the magnetic core coil array to generate a magnetic field through the magnetic core coil array switching unit to drive the movement of the droplets in the microfluidic platform;

After the signal detection unit detects a signal change of the droplets, the signal detection unit feeds back the signal change to the logic control unit, so that the logic control unit activates a next stage of a droplet manipulation path according to the signal change, and controlling an energization or de-energization of each magnetic core coil in the magnetic core coil array through the magnetic core coil array switching unit to generate a corresponding magnetic field.

Optionally, wherein the microfluidic platform is a three-layer sandwich structure.

Wherein the step of filling the microfluidic platform with droplets, and controlling the magnetic core coil array to generate a magnetic field through the magnetic core coil array switching unit to drive the movement of the droplets in the microfluidic platform specifically includes:

When the droplet to be manipulated is a magnetic droplet, filling the microchannel layer of the microfluidic platform with a non-magnetic liquid medium, wherein the non-magnetic liquid medium and the magnetic droplet are immiscible with each other; filling the magnetic droplet from the sample inlet of the microfluidic platform; controlling the magnetic core coil below the magnetic droplet to be energized through the magnetic core coil array switching unit, generating a magnetic field above the magnetic core of the magnetic core coil through electromagnetic induction, and attracting and fixing the magnetic droplet above the magnetic core of the magnetic core coil; controlling the magnetic core coil to be de-energized through the magnetic core coil array switching unit, and controlling an adjacent magnetic core coil of the magnetic core coil to be energized, so that the magnetic droplet is attracted to move above the adjacent magnetic core coil, thereby realizing a movement manipulation of the magnetic droplet;

When the droplet to be manipulated is a non-magnetic droplet, filling the microchannel layer of the microfluidic platform with a magnetic liquid medium, wherein the magnetic liquid medium and the non-magnetic droplet are immiscible with each other; filling the non-magnetic droplet from the sample inlet of the microfluidic platform; controlling the magnetic core coil below the non-magnetic droplet to be energized through the magnetic core coil array switching unit, generating a magnetic field above the magnetic core of the magnetic core coil through electromagnetic induction, the magnetic field attracts the magnetic liquid medium around the non-magnetic droplet, thereby generating a squeezing and repulsive force on the non-magnetic droplet, so that the non-magnetic droplet move above an adjacent non-energized magnetic core coil of the magnetic core coil, thereby realizing a movement manipulation of the non-magnetic droplet.

Optionally, wherein the microfluidic platform is a single-layer hydrophobic platform structure.

Wherein the step of filling the microfluidic platform with droplets, and controlling the magnetic core coil array to generate a magnetic field through the magnetic core coil array switching unit to drive the movement of the droplets in the microfluidic platform specifically includes:

Filling the microfluidic platform above the magnetic core coil array with the magnetic droplet, controlling the magnetic core coil below the magnetic droplet to be energized through the magnetic core coil array switching unit, generating a magnetic field above the magnetic core of the magnetic core coil through electromagnetic induction, and attracting and fixing the magnetic droplet above the magnetic core of the magnetic core coil; controlling the magnetic core coil to be de-energized through the magnetic core coil array switching unit, and controlling an adjacent magnetic core coil of the magnetic core coil to be energized, so that the magnetic droplet is attracted to move above the adjacent magnetic core coil, thereby realizing a movement manipulation of the magnetic droplet.

The present disclosure has the following beneficial effects compared with the prior art:

The present disclosure can manipulate the magnetic droplets or the non-magnetic droplets, or simultaneously manipulate the magnetic droplets and the non-magnetic droplets by using the electromagnetic field generated by a simple magnetic core coil array. For the non-magnetic droplets, three-dimensional manipulation can also be achieved. In addition, the microfluidic platform of the present disclosure is an open platform, which does not require a complex microchannel structure, nor does it require PCB (printed circuit board) circuits and electrodes, and has high expandability. The manufacturing and replacement costs are extremely low. The magnetic core coil array can simultaneously control up to 500 droplets, which greatly improves the efficiency of droplet manipulation.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some of the embodiments of the present disclosure, and a person of ordinary skill in the art can still derive other drawings from the accompanying drawings without creative efforts.

FIG. 1 is a schematic structural diagram of a magnetic digital microfluidic system according to Embodiment 1 of the present disclosure.

FIG. 2 is a schematic structural diagram of a droplet manipulation unit according to Embodiment 1 of the present disclosure.

FIG. 3 is a front elevation view structural diagram of the droplet manipulation unit according to Embodiment 1 of the present disclosure.

FIG. 4 is a cross-sectional view taken at a section line A-A of FIG. 3.

FIG. 5 is a front elevation view structural diagram of the droplet manipulation unit of a magnetic core coil array according to Embodiment 1 of the present disclosure.

FIG. 6 is a side elevation view structural diagram of the droplet manipulation unit of the magnetic core coil array according to Embodiment 1 of the present disclosure.

FIG. 7 is a top elevation view structural diagram of the droplet manipulation unit according to Embodiment 1 of the present disclosure.

FIG. 8 is a schematic structural diagram of a microfluidic platform according to Embodiment 1 of the present disclosure.

FIG. 9 is a schematic diagram of functional areas of the microfluidic platform according to Embodiment 1 of the present disclosure.

FIG. 10 is a schematic structural diagram of the magnetic core coil array according to Embodiment 1 of the present disclosure.

FIG. 11 is a schematic diagram of a magnetic core coil array heat dissipation structure according to Embodiment 1 of the present disclosure.

FIG. 12 is a basic principle diagram showing movements of magnetic droplets according to Embodiment 1 of the present disclosure.

FIG. 13 is a basic principle diagram showing movements of non-magnetic droplets according to Embodiment 1 of the present disclosure.

FIG. 14 is a schematic diagram of droplet transportation in a horizontal direction according to Embodiment 1 of the present disclosure.

FIGS. 15a to 15c are schematic diagrams illustrating one type of droplet distribution and merging in the horizontal direction according to Embodiment 1 of the present disclosure.

FIGS. 16a to 16c are schematic diagrams illustrating another type of droplet distribution and merging in the horizontal direction according to Embodiment 1 of the present disclosure.

FIGS. 17a to 17c are schematic diagrams illustrating movement manipulation control of non-magnetic droplets in a vertical direction according to Embodiment 1 of the present disclosure.

Reference numerals in the accompanying drawings: 1—Droplet manipulation unit, 2—Microfluidic platform, 3—Magnetic core coil array, 4—Magnetic core coil array heat dissipation structure, 5—Magnetic core coil array control connection line, 6—Magnetic core coil array switching unit, 7—Magnetic core coil power connection line, 8—Coil power supply, 9—Signal detection unit, 10—Signal feedback transmission line, 11—Logic control unit, 12—Magnetic core coil switching control line, 13—Logic control unit power supply and transmission line, 14—Human-computer interaction unit, 15—Upper substrate, 16—Microchannel layer, 17—Lower substrate, 18—Medium inlet, 19—Medium outlet, 20—Sample inlet, 21—Microchamber and microchannel structure, 22—Magnetic core, 23—Electromagnetic coil, 24—Droplet basic functional area, 25—Droplet heating functional area, 26—Droplet detection functional area, 27—Magnetic droplet, 28—Non-magnetic droplet, 29—Groove structure.

### DESCRIPTION OF EMBODIMENTS

In order to clarify the purpose, technical solution, and advantages of the embodiments of the present disclosure, the technical solutions in the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

### Embodiment 1

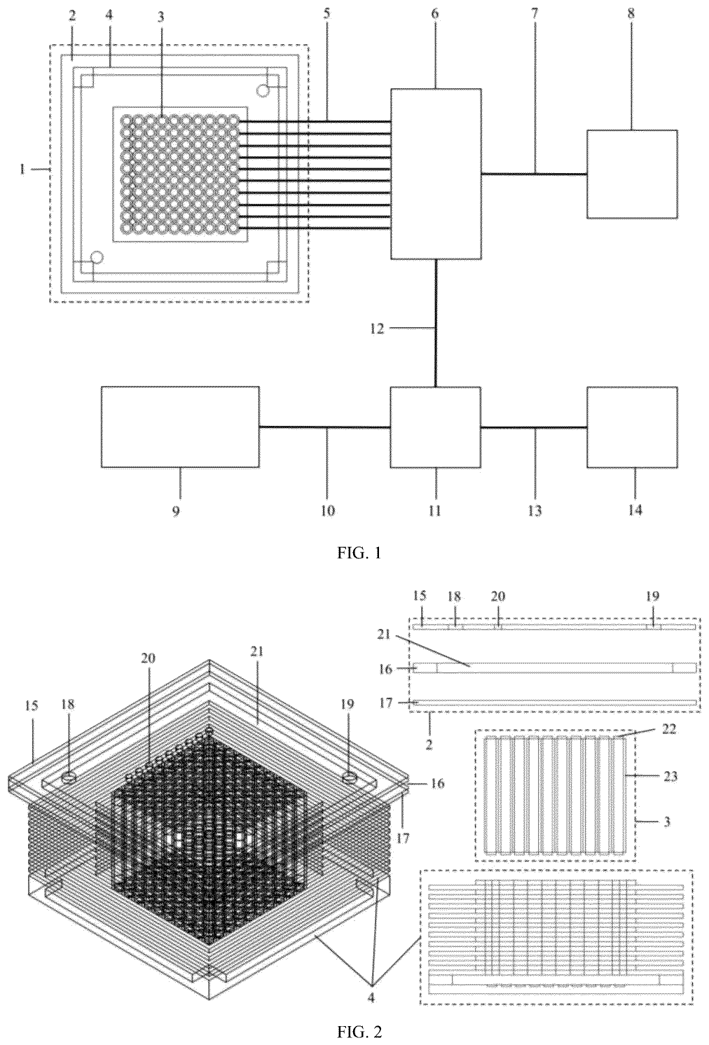

As shown in FIG. 1 and FIG. 2, an embodiment provides a magnetic digital microfluidic system, which includes a droplet manipulation unit 1, a magnetic core coil array switching unit 6, a logic control unit 11, a signal detection unit 9, and a coil power supply 8. The droplet manipulation unit 1 includes a microfluidic platform 2 and a magnetic core coil array 3. The microfluidic platform 2 is used to carry magnetic droplets or non-magnetic droplets and perform various manipulations on the droplets. The droplets include water-based droplets and oil-based droplets. The magnetic core coil array 3 is arranged below the microfluidic platform 2 and is used to generate a magnetic field to drive the movement of the droplets. The magnetic core coil array 3 is connected to the magnetic core coil array switching unit 6. Specifically, each magnetic core coil in the magnetic core coil array 3 is connected to one end of the magnetic core coil array switching unit 6 through a magnetic core coil array control connection line 5, so that an energized or de-energized state of each magnetic core coil can be independently controlled by the magnetic core coil array switching unit 6. Another end of the magnetic core coil array switching unit 6 is connected to the coil power supply 8 through a magnetic core coil power connection line 7. A current adjustment range of the coil power supply 8 is 0-400 A, and it can drive up to 200 magnetic core coils simultaneously. The logic control unit 11 is connected to the magnetic core coil array switching unit 6 and the signal detection unit 9. Specifically, switching points and duration of the magnetic core coil array switching unit 6 are controlled by the logic control unit 11. The magnetic core coil array switching unit 6 and the logic control unit 11 are connected through a magnetic core coil switching control line 12. At the same time, the logic control unit 11 is connected to the signal detection unit 9 through a signal transmission line 10. The magnetic core coil array switching unit 6 is a relay switch array or a field-effect transistor array, and the logic control unit 11 is a microcontroller such as a single-chip microcomputer or a chip.

Optionally, the signal detection unit 9 of the embodiment is arranged above the microfluidic platform 2. According to different application requirements, a color detector, a fluorescence detector, or a thermal infrared detector can be used. After detecting a signal change of the droplets, the signal change is fed back to the logic control unit 11, which then automatically activates a next stage of a droplet manipulation path according to the signal change, and controls a magnetic core coil energization or de-energization program, so that the magnetic core coil array switching unit 6 performs corresponding operations of energizing or de-energizing the magnetic core coils.

Optionally, the magnetic digital microfluidic system of the embodiment also includes a human-computer interaction unit 14, which is connected to the logic control unit 11. Specifically, the human-computer interaction unit 14 and the logic control unit 11 are connected through a logic control unit power supply and transmission line 13. After the signal detection unit 9 feeds back the signal change to the logic control unit 11, the signal change can be collected and displayed through the human-computer interaction unit 14. An interactive software in the human-computer interaction unit 14 can customize an arrangement of the coil array and a coil energization or de-energization control process. Adjustment parameters include the arrangement of the coil array, a coil selection, an energization duration, a current magnitude and an energization switching time. It also has a photoelectric detection signal acquisition program and a feedback control program. Through the software, a plurality of channels and control processes can be customized, and the logic control unit 11 can automatically execute the coil energization or de-energization program according to the defined process.

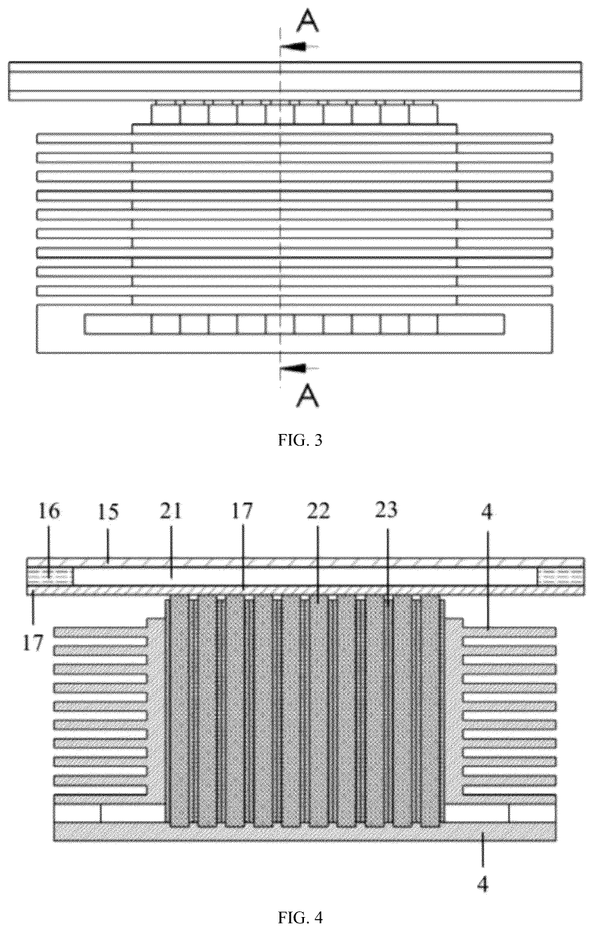

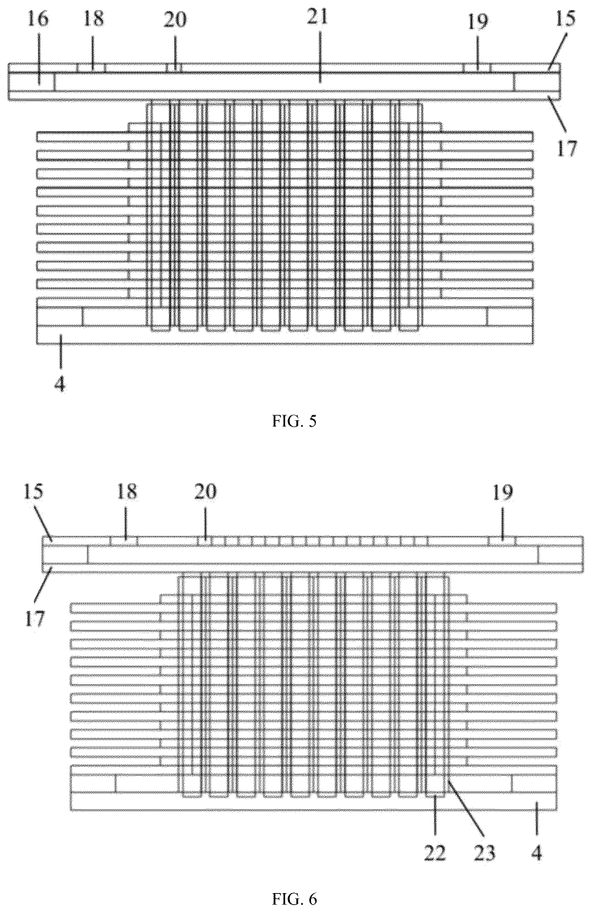

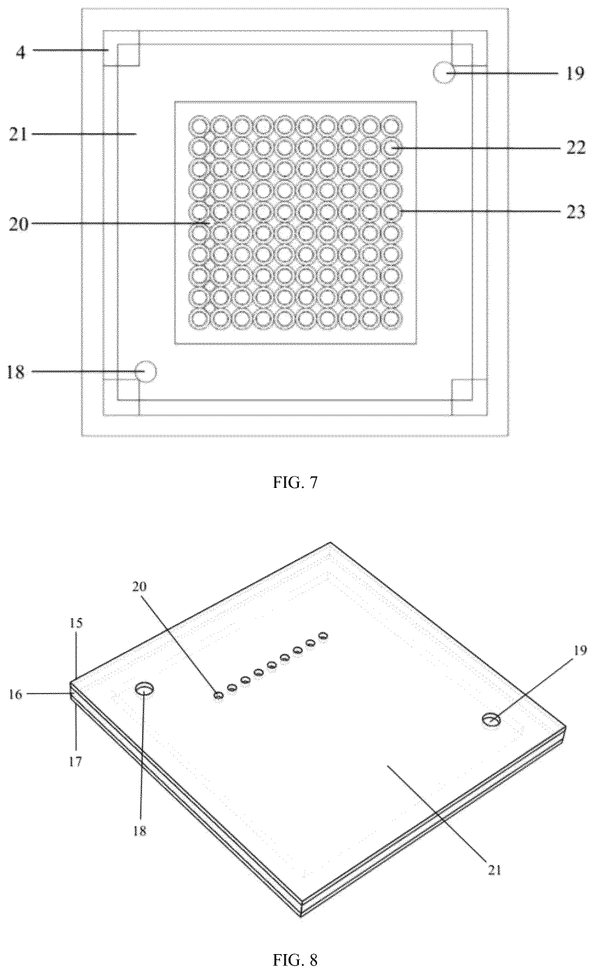

As shown in FIGS. 2 to 8, the microfluidic platform 2 in the droplet manipulation unit 1 is a three-layer sandwich structure, which includes an upper substrate 15, a microchannel layer 16, and a lower substrate 17 arranged in sequence from top to bottom. The upper substrate 15 includes a medium inlet 18, a medium outlet 19, and a sample inlet 20. The medium inlet 18 and the medium outlet 19 are located at a periphery of the magnetic core coil array 3 (i.e., there is no magnetic core coils below them), and the sample inlet 20 is located above the magnetic core coil array 3. The microchannel layer 16 includes a microchamber and microchannel structure 21, which is located directly above the magnetic core coil array 3. An area covered by the microchamber and microchannel structure 21 is larger than a cross-section of the magnetic core coil array 3. The microchamber and microchannel structure 21 is separated from the magnetic core coil array 3 by the lower substrate 17, and the microchamber and microchannel structure 21 is connected to the medium inlet 18, the medium outlet 19, and the sample inlet 20.

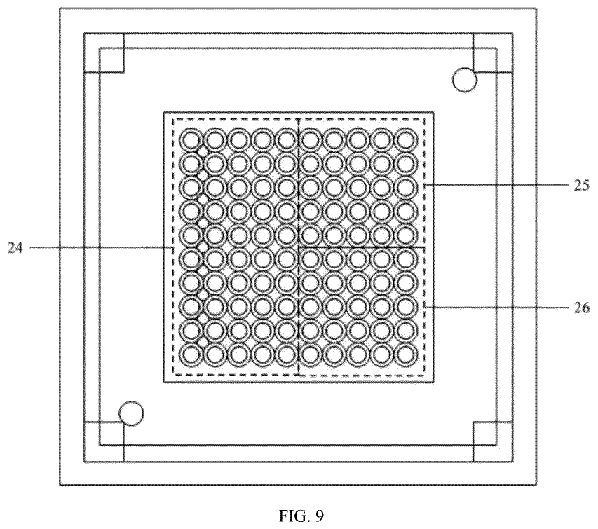

Further, the microchamber and microchannel structure 21 can be divided into different functional areas according to application requirements, as shown in FIG. 9, such as a droplet basic functional area 24, a droplet heating functional area 25, and a droplet detection functional area 26. Each functional area can be freely defined according to an arrangement shape of the magnetic core coil array 3 and application requirements. The droplet basic functional area 24 is connected to the sample inlet 20, and droplet basic functions of the droplet basic functional area 24 include droplet transportation, merging and distribution. In the droplet heating functional area 25, a heating temperature range of the droplets is 0° C.-99° C.

Further, a thickness of the lower substrate 17 is 0.1 mm-2 mm, and a thickness of the microchannel layer 16, that is, a height of the microchamber and microchannel structure 21, is 0.05 mm-10 mm. A control area of the magnetic core coil array 3 can cover all the functional areas in the microchamber and microchannel structure 21, that is, the control area of the magnetic core coil array 3 can cover the droplet basic functional area 24, the droplet heating functional area 25, and the droplet detection functional area 26, so that there is a magnetic core coil below the sample inlet 20. A number of the sample inlet 20 is 1-500. The microchamber and microchannel structure 21 of the microchannel layer 16 is processed by laser cutting, mechanical cutting and punching, etc. A material of the upper substrate 15 is a transparent plastic film, acrylic plate, or glass sheet, etc., and materials of the lower substrate 17 and the microchamber and microchannel structure 21 are transparent or opaque plastic film, acrylic plate, glass sheet, ceramic sheet, polydimethylsiloxane (PDMS), etc. Different layers of the microfluidic platform 2 are sealed using gluing, hot pressing, bonding, or clip fastening, etc.

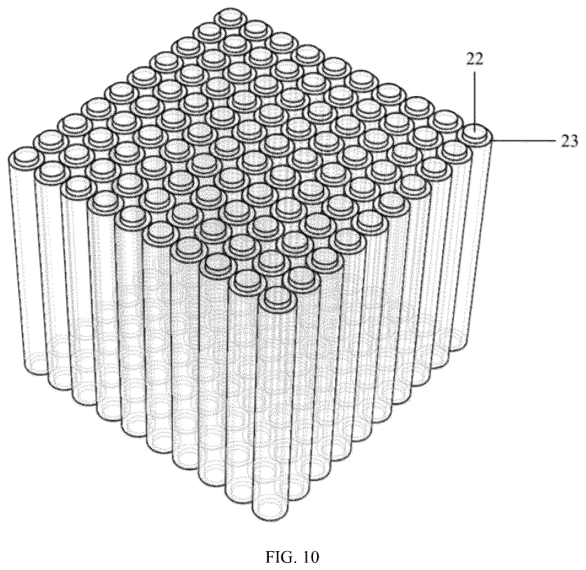

A structure of the magnetic core coil array 3 is shown in FIG. 10, which includes a plurality of magnetic core coils. Each magnetic core coil includes a magnetic core 22 and an electromagnetic coil 23. The electromagnetic coil 23 is wound with wires, so that the electromagnetic coil 23 is tightly wound around the magnetic core 22.

Further, a number of the magnetic core coils is 1-10000, which can be arranged into any shape, such as a 10×10 array or other arbitrary shapes. The magnetic core 22 can be a columnar body with a cross-section of any shape (for example, the cross-section is a circular, a rectangular, a triangular, etc.). The magnetic core 22 of the embodiment is cylindrical (as shown in FIG. 10) with a length of 1 mm-200 mm and a cross-sectional area of 0.1 mm²-20 mm². The magnetic core is made of a high magnetic permeability alloy, such as permalloy, silicon steel, ferrite, etc. The magnetic core can be an integrated structure or stacked from sheet-like structures. It is easy for those skilled in the art to understand that in addition to the cylinder, the magnetic core 22 can also be an “I”-shaped structure with thick ends and a thin middle part. The electromagnetic coil 23 is wound around the thin middle cylinder of the “I”-shaped structure, with a length of 1 mm-200 mm and a cross-sectional area of 0.1 mm²-20 mm². A length of the two ends is 0.1-5 mm, and a cross-sectional area is 0.2 mm²-40 mm². A diameter of the wires for winding the electromagnetic coil 23 is 0.02 mm-5 mm, and the wires are tightly wound around the magnetic core cylinder to form a solenoid-shaped electromagnetic coil. A number of winding layers of the solenoid is 1-500. The wires are made of conductive materials such as copper, aluminum, silver, etc., with their surfaces coated with insulating paint.

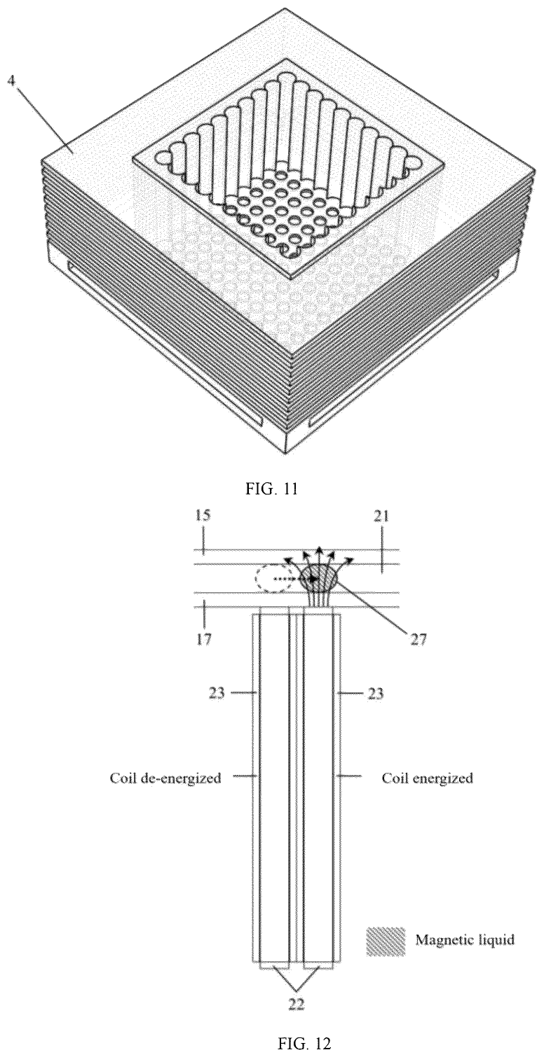

As shown in FIG. 11, the droplet manipulation unit 1 of the embodiment further includes a magnetic core coil array heat dissipation structure 4. The magnetic core coil array heat dissipation structure 4 is a heat sink structure customized according to a shape of the magnetic core coil array 3, and is stacked and nested on an outer contour of the magnetic core coil array 3. In addition to a heat dissipation function, it also plays a role in fixing the magnetic core coils.

Further, the magnetic core coil array heat dissipation structure 4 is made of materials with high thermal conductivity and non-magnetic properties, such as aluminum oxide, aluminum nitride, graphite, thermal conductive silicone, sapphire/ruby glass, etc. Each piece of the magnetic core coil array heat dissipation structure 4 is processed by means of laser cutting or the like into a shape capable of wrapping the magnetic core coil array 3, and is stacked and nested on the outer contour of the magnetic core coil array 3, which not only plays a role in heat dissipation but also fixes the magnetic core coil array 3.

In the embodiment, in the droplet basic functional area 24, the magnetic droplets and the non-magnetic droplets can be manipulated in terms of transportation, merging, and distribution in a horizontal direction, as well as three-dimensional movement manipulation in a vertical direction.

When manipulating magnetic droplets, first, the microchamber and microchannel structure 21 is filled with a non-magnetic liquid medium through the medium inlet 18, wherein the non-magnetic liquid medium and the magnetic droplets are immiscible with each other. For example, the magnetic droplets can be water-based magnetic fluids, magnetic salt solutions, or aqueous solutions containing magnetic beads, while the non-magnetic liquid medium can be oil-based mineral oil or the like. Alternatively, the magnetic droplets can be oil-based sample solutions, while the non-magnetic liquid medium can be water-based pure water or the like. Then, the magnetic droplets are dripped into the microchamber and microchannel structure 21 from the sample inlet 20, and at this time, the magnetic droplets will be located above the magnetic core coils. The basic principle of the movement of the magnetic droplets is shown in FIG. 12. When the magnetic core coil below the magnetic droplet is energized, a magnetic field can be generated above the magnetic core of the magnetic core coil through electromagnetic induction, attracting and fixing the magnetic droplets above the magnetic core of the magnetic core coil. Then, when the magnetic core coil is de-energized and an adjacent magnetic core coil of the magnetic core coil is energized, the magnetic droplets will be attracted to move above the adjacent magnetic core coil. That is, the magnetic droplets are attracted by utilizing the magnetophoresis effect, and by controlling a sequence of energization or de-energization of the underlying magnetic core coils to generate magnetic field changes, the magnetic droplets can be attracted to move along a predetermined path, thereby realizing movement manipulation of the magnetic droplets.

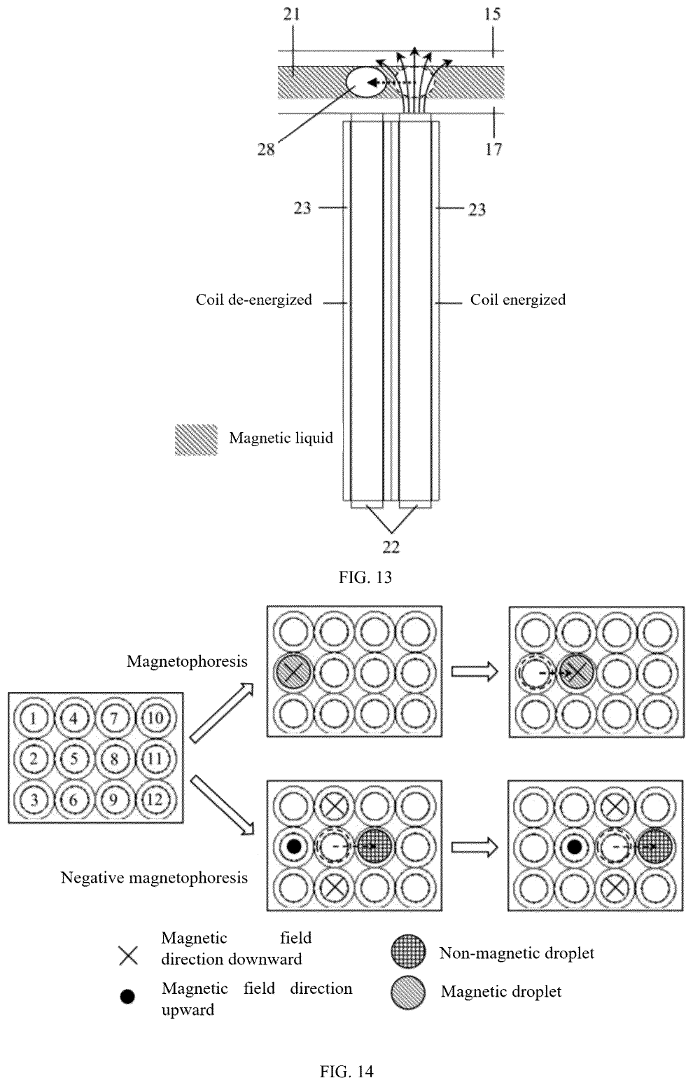

When manipulating the non-magnetic droplets, first, the microchamber and microchannel structure 21 is filled with a magnetic liquid medium through the medium inlet 18, wherein the magnetic liquid medium and the non-magnetic droplets are immiscible with each other. For example, the magnetic liquid medium can be a water-based magnetic fluid, a magnetic salt solution, or an aqueous solution containing magnetic beads, while the non-magnetic droplets can be oil-based mineral oil and other samples. Alternatively, the magnetic liquid medium can be an oil-based magnetic solution, while the non-magnetic droplets can be water-based pure water, cell culture fluid, or the like. Then, the magnetic droplets are dripped into the microchamber and microchannel structure 21 from the sample inlet 20, and at this time, the magnetic droplets will be located above the magnetic core coils. The basic principle of the movement of the non-magnetic droplets is shown in FIG. 13. When the magnetic core coil below the magnetic droplets is de-energized, there is no magnetic field in the upper microchamber and microchannel structure 21, and at this time, the non-magnetic droplets in the magnetic liquid medium will stay at the sample inlet 20 as they are not subjected to any force. When the magnetic core coil below the magnetic droplets is energized while the adjacent magnetic core coil of the magnetic core coil is de-energized, a magnetic field can be generated above the magnetic core of the magnetic core coil through electromagnetic induction. The magnetic field can attract the magnetic liquid medium around the non-magnetic droplets, thereby generating a squeezing and repulsive force on the non-magnetic droplets. That is, the non-magnetic droplets in the magnetic liquid medium are repelled by utilizing the negative magnetophoresis effect, so that the non-magnetic droplets move above the adjacent non-energized magnetic core coil of the magnetic core coil, thereby realizing the movement manipulation of the non-magnetic droplets. Here, by energizing a plurality of coils around the droplets at the same time to generate a directional repulsive force, the non-magnetic droplets can be precisely controlled to move toward a predetermined direction without a magnetic field. In addition, the non-magnetic droplets can also move up and down in the vertical direction under the repulsive force of the magnetic field, thereby realizing three-dimensional movement manipulation of the non-magnetic droplets.

The droplet transportation in the horizontal direction is shown in FIG. 14. For better illustration, the magnetic core coils are labeled here, i.e., No. 1 to No. 12. For the magnetic droplets, their movement is achieved by magnetic field attraction, i.e., magnetophoretic force. In FIG. 14, when the No. 2 magnetic core coil is energized, the magnetic droplets are fixed above the No. 2 magnetic core coil due to the attraction of the magnetic force; when the No. 2 magnetic core coil is de-energized and the No. 5 magnetic core coil is energized, the magnetic force of the No. 2 magnetic core coil disappears, and the No. 5 magnetic core coil will generate an attractive force on the magnetic droplet, thereby driving the magnetic droplets to move from above the No. 2 magnetic core coil to above the No. 5 magnetic core coil. At this point, the basic transportation of the magnetic droplets is completed. By manipulating the energization sequence and time of the coils, the magnetic droplets can be controlled to transport and move along any path. For the non-magnetic droplets, to precisely control their movement direction, first, the No. 2, No. 4, and No. 6 magnetic core coils are energized, and a current direction of the No. 2 magnetic core coil is opposite to that of the other two magnetic core coils, that is, the generated magnetic field directions are opposite. Thus, a groove-shaped magnetic field will be formed above the No. 4-No. 2-No. 6 magnetic core coils. At this time, the non-magnetic droplets above the No. 5 magnetic core coil are subjected to a negative magnetophoretic repulsive force generated by the magnetic field, thereby moving toward the No. 8 magnetic core coil. Similarly, then the No. 2, No. 4, and No. 6 magnetic core coils are then de-energized, and the No. 5, No. 7, and No. 9 magnetic core coils are energized. At this time, the non-magnetic droplets will continue to be subjected to the negative magnetophoretic repulsive force and move toward above the No. 11 magnetic core coil. By customizing the energization status of the coils, precise transportation and manipulation of the non-magnetic droplets can be realized.

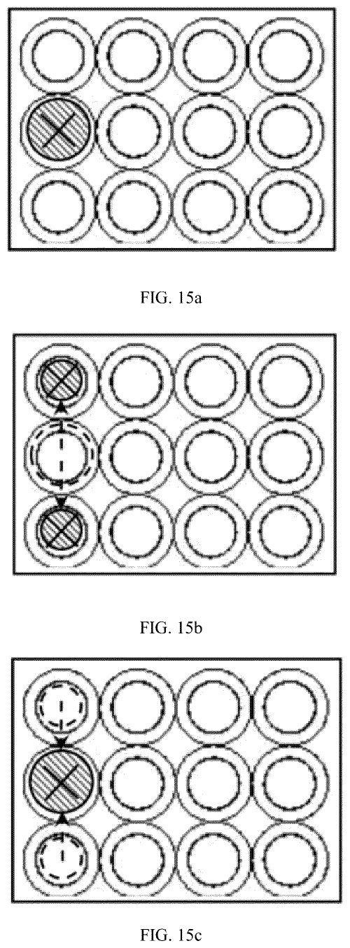

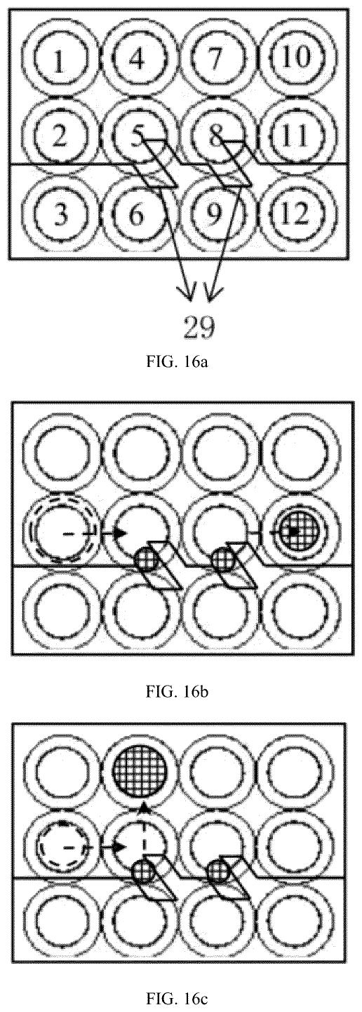

The droplet distribution and merging in the horizontal direction are shown in FIGS. 15a to 15c and FIGS. 16a to 16c. There are two forms of droplet distribution and merging. The first form is for magnetic droplets: by de-energizing the magnetic core coil below the magnetic droplet and energizing the two adjacent magnetic core coils at the same time, the magnetic droplet can be split into two parts, which are respectively attracted to above the two adjacent magnetic core coils. When merging is required, the two adjacent magnetic core coils are de-energized, and then the middle magnetic core coil is energized, so that the two separated magnetic droplets can be attracted to the middle to realize droplet merging, as shown in FIGS. 15a to 15c. 5c. The second form is for magnetic droplets or non-magnetic droplets: this form needs to rely on edge-assisted microstructures, i.e., a groove structure 29 as shown in the figures is pre-cut in the microchamber and microchannel structure 21 of the microchannel layer 16. By using the aforementioned droplet manipulation method to make the droplets move close to an edge of the groove structure 29, the droplets can be distributed into the groove structure 29. A volume of the droplets remaining in the groove structure is determined by a size of the groove structure. When droplet merging is required, it is only necessary to drive droplets to the groove structure 29 and make the two droplets contact and merge, as shown in FIGS. 16a to 16c.

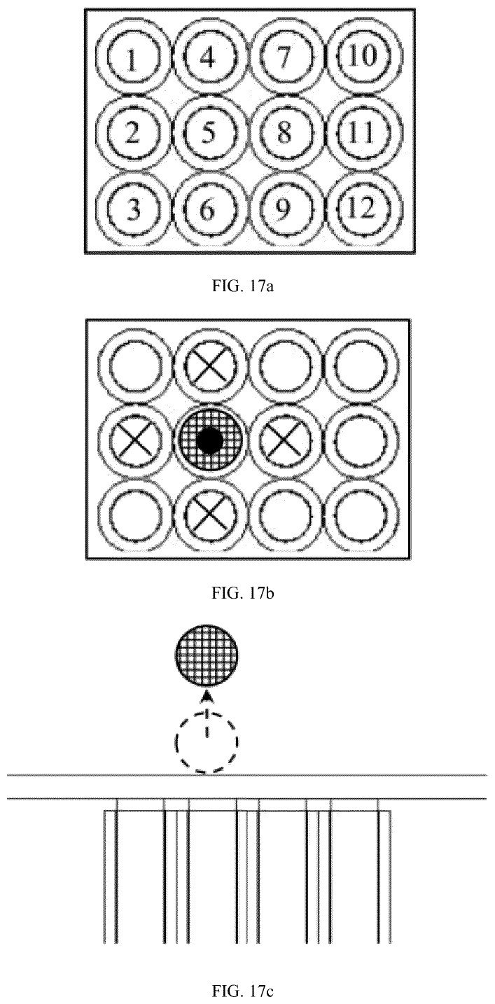

Since non-magnetic droplets are driven by negative magnetophoretic repulsive force, the non-magnetic droplets can also move in the vertical direction, realizing the three-dimensional manipulation of the non-magnetic droplets. The vertical movement manipulation is shown in FIGS. 17a to 17c. First, the magnetic core coils around the non-magnetic droplets are energized to generate a magnetic field, and the non-magnetic droplets are fixed above the middle magnetic core coil by the negative magnetophoretic repulsive force. Then, the middle magnetic core coil is energized, and its current is adjusted to be always smaller than that of the surrounding coils, i.e., the magnetic field generated by the middle magnetic core coil is smaller than that generated by the surrounding coils. In this way, the non-magnetic droplets are subjected to the repulsive force of the magnetic field of the middle magnetic core coil and rise. At the same time, due to the stronger surrounding magnetic fields, the non-magnetic droplets will not move around, thus realizing their movement in the vertical direction. Combined with the movement of non-magnetic droplets in the horizontal direction, the magnetic digital microfluidic system of the embodiment can perform three-dimensional movement manipulation of the non-magnetic droplets.

Further, a volume range of the droplets (including the magnetic droplets and the non-magnetic droplets) manipulated in the embodiment is 1 pL-100 μL, and a moving speed of the droplets is 1 μm/s-20 mm/s.

In addition, the magnetic digital microfluidic system of the embodiment can also manipulate the magnetic droplets and the non-magnetic droplets at the same time. When a magnetic susceptibility of the magnetic liquid medium (immiscible with the droplets) is between that of the magnetic droplets and the non-magnetic droplets, that is, the magnetic susceptibility of the magnetic liquid medium is greater than that of the non-magnetic droplets but less than that of the magnetic droplet. At this time, under an action of the magnetic field, the magnetic droplets are subjected to the magnetophoretic repulsive force to move toward the magnetic field, while the non-magnetic droplets are subjected to the negative magnetophoretic repulsive force to move away from the magnetic field. First, the microchamber and microchannel structure 21 is filled with the magnetic liquid medium through the medium inlet 18. Then, the magnetic droplets and the non-magnetic droplets are dropped into the microchamber and microchannel structure 21 from the sample inlet 20. Finally, by adopting the above-mentioned schemes for manipulating the magnetic droplets and the non-magnetic droplets, the simultaneous manipulation of the magnetic droplets and the non-magnetic droplets can be achieved.

In the droplet heating functional area 25, the magnetic digital microfluidic system of the embodiment can heat the droplets according to a temperature required for droplet manipulation or reaction, and a heating temperature range of the droplets is 0° C.-99° C. The droplet heating functional area 25 can be used for various chemical reactions or biological reactions such as nucleic acid amplification. First, the droplets are transported to the droplet heating functional area 25 through the transportation function of the system, and then the magnetic core coil below the heating functional area 25 is energized, at this time, both the electromagnetic coil 23 and the magnetic core 22 will generate heat, and a heating amplitude and a rate increase with the increase of current. Finally, the heat is conducted to the microchamber in the droplet heating functional area 25 through the lower substrate 17 to heat the droplets in the microchamber. A heating temperature and duration can be controlled by the current magnitude and the energization time, and the temperature range of the droplets here can be controlled within 0° C.-99° C.

The signal detection unit 9 is arranged above the droplet detection functional area 26. The signal detection unit 9 is a sensor for detecting states of the droplets, such as a color sensor for detecting color changes of the droplets, a fluorescence sensor for detecting fluorescence changes of the droplets, or an infrared sensor for detecting temperature changes of the droplets, etc. When the droplets are used for specific marker detection, a specific fluorescent dye can be co-incubated with a droplet sample for a period of time, whereby the marker will be stained and emit fluorescence, so that the specific marker in the droplet sample can be detected by the fluorescence sensor. When the droplet sample is used for nucleic acid amplification and extraction, a fluorescence, a color or a temperature of the droplet sample may change, and at this time, the droplets can be detected by the fluorescence sensor, the color sensor or the thermal infrared sensor. The reaction progress or state of the droplet sample can be determined by the detection signal, so as to determine the sample manipulation steps in the next stage.

The droplet manipulation is realized by the magnetic field generated by the magnetic core coil array 3 below the microfluidic platform 2, and the magnetic field is generated by the electromagnetic effect of the coils. First, each coil of the magnetic core coil array 3 is connected to the magnetic core coil array switching unit 6, and the magnetic core coil array switching unit 6 can be a control unit such as a switch array or a field effect transistor. One end of the magnetic core coil array switching unit 6 is connected to the magnetic core coil array 3 through the magnetic core coil array control connection line 5, and the other end is connected to the coil power supply 8 through the magnetic core coil power connection line 7. Whether each coil is energized or de-energized, the current magnitude and direction, and the logical sequence of energization or de-energization are controlled by the logic control unit 11. The logic control unit 11 controls the energization or de-energization of the magnetic core coil array switching unit 6 through the magnetic core coil switching control line 12, thereby controlling the energization or de-energization of each coil in the magnetic core coil array 3 to generate a corresponding magnetic field. The logic control unit 11 is a single-chip microcomputer or a programmable integrated chip. In addition, the signal of the signal detection unit 9 is also fed back to the logic control unit 11 through a signal feedback transmission line 10, which is used for signal collection and determining the droplet manipulation in the next stage. Finally, the logic control unit 11 is connected to the human-computer interaction unit 14 through the logic control unit power supply and transmission line 13, so as to realize human-computer interaction control in the single-chip microcomputer or computer, and realize the customized functions of droplet manipulation paths and signal collection and output.

The magnetic digital microfluidic system of the embodiment can realize energization or de-energization control of any magnetic core coil in the magnetic core coil array 3, including individual control of a single magnetic core coil and simultaneous control of the plurality of magnetic core coils. An upper limit of multi-channel simultaneous control is a number of the magnetic core coils in the magnetic core coil array 3. A current adjustment range of the magnetic core coils is 0.2 A-4 A, a control mode is constant current mode, and a current direction of each magnetic core coil can be independently adjusted. An energization duration of the magnetic core coil is 0.1 s-2 s, and an energization switching time of the magnetic core coil is 0 s-0.1 s. System parameters are controlled by the human-computer interaction software, which can customize the arrangement of the magnetic core coil array 3 and a magnetic core coil energization or de-energization control process. The adjustment parameters include the arrangement of the magnetic core coil array 3, the magnetic core coil selection, the energization duration, the current magnitude and the energization switching time. It also has the photoelectric detection signal acquisition program and the feedback control program.

### Embodiment 2

A magnetic digital microfluidic system of the embodiment includes a droplet manipulation unit, a magnetic core coil array switching unit, a logic control unit, a signal detection unit, a coil power supply, and a human-computer interaction unit. The droplet manipulation unit includes a microfluidic platform and a magnetic core coil array. A difference lies that the microfluidic platform is a single-layer hydrophobic platform structure, which can only manipulate magnetic droplets. Specifically, the magnetic droplets are dropped onto the microfluidic platform above the magnetic core coil array. When the magnetic core coil below the magnetic droplets is energized, a magnetic field is generated above the magnetic core of the magnetic core coil through electromagnetic induction, attracting and fixing the magnetic droplets above the magnetic core of the magnetic core coil. Then, the magnetic core coil is de-energized, and an adjacent magnetic core coil of the magnetic core coil is energized, so that the magnetic droplets are attracted to move above the adjacent magnetic core coil, thereby realizing the movement manipulation of the magnetic droplets.

In summary, the magnetic digital microfluidic system of the present disclosure has the following advantages:

1) The present disclosure can manipulate both magnetic droplets and non-magnetic droplets by utilizing the electromagnetic field generated by the simple magnetic core coil array, thereby completely solving the problems of poor biocompatibility and dependence on magnetic beads in magnetic digital microfluidics.

2) The microfluidic platform of the present disclosure has no complex microchannel structures or electrodes, and the movement path of droplets can be customized. It is an open platform with high scalability and can realize various manipulations such as droplet transportation, merging, distribution, heating and detection, and thus has extensive applications in the biochemistry field.

3) The magnetic core coil array of the present disclosure can be reused, and the microfluidic platform only has a simple Microchamber without complex PCB circuits or electrodes. In response to different application requirements, the microfluidic platform can be replaced at an extremely low cost.

The above descriptions are only preferred embodiments of the present disclosure, but the present disclosure is not limited to the above embodiments. Any other changes, modifications, substitutions, combinations, or simplifications made without departing from the spirit and principles of the present disclosure should be equivalent substitutions, and are included in the protection scope of the present disclosure.

What is claimed is:

1. A magnetic digital microfluidic system, comprising a droplet manipulation unit, a magnetic core coil array switching unit, a logic control unit and a signal detection unit, wherein the droplet manipulation unit comprises a microfluidic platform and a magnetic core coil array, the magnetic core coil array is arranged below the microfluidic platform and connected to the magnetic core coil array switching unit, and the logic control unit is connected to the magnetic core coil array switching unit and the signal detection unit, the magnetic core coil array can generate a magnetic field to directly drive magnetic droplets and non-magnetic droplets in the microfluidic platform.

2. The magnetic digital microfluidic system according to claim 1, wherein the droplet manipulation unit further comprises a magnetic core coil array heat dissipation structure, and the magnetic core coil array heat dissipation structure is stacked and nested on an outer contour of the magnetic core coil array.

3. The magnetic digital microfluidic system according to claim 2, wherein the magnetic core coil array heat dissipation structure is a heat sink structure customized according to a shape of the magnetic core coil array.

4. The magnetic digital microfluidic system according to claim 1, wherein the microfluidic platform is a three-layer sandwich structure, comprising an upper substrate, a microchannel layer and a lower substrate arranged in sequence from top to bottom;
the upper substrate comprises a medium inlet, a medium outlet and a sample inlet, the medium inlet and the medium outlet are located at a periphery of the magnetic core coil array, and the sample inlet is located above the magnetic core coil array.

5. The magnetic digital microfluidic system according to claim 4, wherein the microchannel layer comprises a microchamber and microchannel structure, the microchamber and microchannel structure comprises a droplet basic functional area, a droplet heating functional area and a droplet detection functional area, a control area of the magnetic core coil array covers the droplet basic functional area, the droplet heating functional area and the droplet detection functional area, the droplet basic functional area is connected to the sample inlet, basic functions of the droplet basic functional area comprising a droplet transportation, a merging and a distribution, and the signal detection unit is arranged above the droplet detection functional area.

6. The magnetic digital microfluidic system according to claim 5, wherein the droplet heating functional area heats the droplets according to a temperature required for droplet manipulation or reaction, and a heating temperature range of the droplets is 0° C.-99° C.

7. The magnetic digital microfluidic system according to claim 6, wherein a heating process of the droplet heating functional area is achieved through the following steps:
the droplets are transported to the droplet heating functional area through the transportation function of the system, and then the magnetic core coil below the heating functional area is energized, at this time, both the electromagnetic coil and the magnetic core will generate heat, and a heating amplitude and a rate increase with the increase of current, finally, the heat is conducted to the microchamber in the droplet heating functional area through the lower substrate to heat the droplets in the microchamber.

8. The magnetic digital microfluidic system according to claim 6, wherein the heating temperature and duration is controlled by the current magnitude and the energization time.

9. The magnetic digital microfluidic system according to claim 8, wherein a current adjustment range of the magnetic core coils is 0.2 A-4 A, and an energization duration of the magnetic core coil is 0.1 s-2 s.

10. The magnetic digital microfluidic system according to claim 4, the microchannel layer comprises a microchamber and microchannel structure are located directly above the magnetic core coil array, an area covered by the microchamber and microchannel structure is larger than a cross-section of the magnetic core coil array, the microchamber and microchannel structure is separated from the magnetic core coil array by the lower substrate, and are connected to the medium inlet, the medium outlet, and the sample inlet.

11. The magnetic digital microfluidic system according to claim 1, wherein the microfluidic platform is a single-layer hydrophobic platform structure.

12. The magnetic digital microfluidic system according to claim 1, wherein the magnetic core coil array comprises a plurality of magnetic core coils, and the magnetic core coil array can be arranged into any array shape through the plurality of magnetic core coils, and each magnetic core coil comprises a magnetic core and an electromagnetic coil, and the electromagnetic coil is tightly wound around the magnetic core.

13. The magnetic digital microfluidic system according to claim 12, wherein the magnetic core is a columnar body with a cross-section of any shape, a length of 1 mm-200 mm and a cross-sectional area of 0.1 mm²-20 mm².

14. The magnetic digital microfluidic system according to claim 1, further comprising a human-computer interaction unit, which is connected to the logic control unit.

15. The magnetic digital microfluidic system according to claim 14, wherein the human-computer interaction unit customizes an arrangement of the coil array and a coil energization or de-energization control process.

16. A microfluidic method, implemented based on the magnetic digital microfluidic system according to claim 1, the method comprising:
filling the microfluidic platform with droplets, and controlling the magnetic core coil array to generate a magnetic field through the magnetic core coil array switching unit to drive the movement of the droplets in the microfluidic platform;
after the signal detection unit detects a signal change of the droplets, the signal detection unit feeds back the signal change to the logic control unit, so that the logic control unit activates a next stage of a droplet manipulation path according to the signal change, and controlling an energization or de-energization of each magnetic core coil in the magnetic core coil array through the magnetic core coil array switching unit to generate a corresponding magnetic field.

17. The microfluidic method according to claim 16, wherein the microfluidic platform is a three-layer sandwich structure;
the step of filling the microfluidic platform with droplets, and controlling the magnetic core coil array to generate a magnetic field through the magnetic core coil array switching unit to drive the movement of the droplets in the microfluidic platform comprises:
when the droplet to be manipulated is a magnetic droplet, filling the microchannel layer of the microfluidic platform with a non-magnetic liquid medium, wherein the non-magnetic liquid medium and the magnetic droplet are immiscible with each other; filling the magnetic droplet from the sample inlet of the microfluidic platform; controlling the magnetic core coil below the magnetic droplet to be energized through the magnetic core coil array switching unit, generating a magnetic field above the magnetic core of the magnetic core coil through electromagnetic induction, and attracting and fixing the magnetic droplet above the magnetic core of the magnetic core coil; controlling the magnetic core coil to be de-energized through the magnetic core coil array switching unit, and controlling an adjacent magnetic core coil of the magnetic core coil to be energized, so that the magnetic droplet is attracted to move above the adjacent magnetic core coil, thereby realizing a movement manipulation of the magnetic droplet;
when the droplet to be manipulated is a non-magnetic droplet, filling the microchannel layer of the microfluidic platform with a magnetic liquid medium, wherein the magnetic liquid medium and the non-magnetic droplet are immiscible with each other; filling the non-magnetic droplet from the sample inlet of the microfluidic platform; controlling the magnetic core coil below the non-magnetic droplet to be energized through the magnetic core coil array switching unit, generating a magnetic field above the magnetic core of the magnetic core coil through electromagnetic induction, the magnetic field attracts the magnetic liquid medium around the non-magnetic droplet, thereby generating a squeezing and repulsive force on the non-magnetic droplet, so that the non-magnetic droplet move above an adjacent non-energized magnetic core coil of the magnetic core coil, thereby realizing a movement manipulation of the non-magnetic droplet.

18. The microfluidic method according to claim 16, wherein the microfluidic platform is a single-layer hydrophobic platform structure;
the step of filling the microfluidic platform with droplets, and controlling the magnetic core coil array to generate a magnetic field through the magnetic core coil array switching unit to drive the movement of the droplets in the microfluidic platform comprises:
filling the microfluidic platform above the magnetic core coil array with the magnetic droplet, controlling the magnetic core coil below the magnetic droplet to be energized through the magnetic core coil array switching unit, generating a magnetic field above the magnetic core of the magnetic core coil through electromagnetic induction, and attracting and fixing the magnetic droplet above the magnetic core of the magnetic core coil; controlling the magnetic core coil to be de-energized through the magnetic core coil array switching unit, and controlling an adjacent magnetic core coil of the magnetic core coil to be energized, so that the magnetic droplet is attracted to move above the adjacent magnetic core coil, thereby realizing a movement manipulation of the magnetic droplet.

19. The microfluidic method according to claim 16, further comprising:
the magnetic core coils around the non-magnetic droplets are energized to generate a magnetic field, and the non-magnetic droplets are fixed above the middle magnetic core coil by the negative magnetophoretic repulsive force, then, the middle magnetic core coil is energized, and its current is adjusted to be always smaller than that of the surrounding coils, the non-magnetic droplets is subjected to the repulsive force of the magnetic field of the middle magnetic core coil and rise, thus realizing their movement in the vertical direction.
